(19) United States
(12) Patent Application Publication
(10) Pub. No.: US 2018/0316787 A1
(43) Pub. Date: Nov. 1, 2018

(54) HOUSING FOR A MOBILE TELEPHONE TO CREATE A HOME SECURITY SYSTEM

(71) Applicant: Donald SPECTOR, New York, NY (US)

(72) Inventor: Donald SPECTOR, New York, NY (US)

(21) Appl. No.: 15/598,621

(22) Filed: May 18, 2017

Related U.S. Application Data
(60) Provisional application No. 62/492,271, filed on Apr. 30, 2017.

(51) Int. Cl. H04M 1/725; H04B 1/3877; H04R 1/02; H04N 7/18

(52) U.S. Cl. CPC H04M 1/72527; H04B 1/3877; H04R 2499/11; H04N 7/186; H04R 1/028

(57) ABSTRACT

A housing for a mobile telephone has a bottom wall, top wall and two side walls and a front surface connected to at least one of the walls. The front surface is formed of a two-way mirrored surface so that the interior of the housing is not visible from the outside but the outside is visible from the interior of the housing. Inside the housing there is a connection to a power supply disposed in the housing, a transformer connected to the power supply, a microphone and a connector for connecting a mobile telephone to the transformer, the connector being positioned so that when the mobile telephone is connected, a camera on the mobile telephone faces the front surface and can record images outside the housing for transmission to a remote site.

### BACKGROUND OF THE INVENTION

### 1. Field of the Invention

This invention relates to a housing for a mobile telephone, which turns the mobile telephone into a home security or monitoring system. In particular, the housing includes a transformer, power supply, and an enhanced microphone to convert the mobile telephone into a home security camera and communication device.

### 2. The Prior Art

Mobile telephones often have a useful life of only a few years. Even if the mobile telephone is in perfect working condition, the user often discards it to upgrade to a new model. Much of the technology in such mobile telephones is similar to technology used in various other electronic devices. For example, a home security system utilizes a camera, microphone, and computerized communication between the system and a central station. Likewise, a mobile telephone also has a camera, microphone and communication capability, via wireless internet, even if the cellular service has been discontinued. It would be ideal to create a way to conveniently re-use the working elements of a discarded mobile device in a home electronic system.

### SUMMARY OF THE INVENTION

It is therefore an object of the invention to provide a structure that can convert a mobile telephone into a home security or monitoring system. This object is achieved by a housing for a mobile telephone comprising a bottom wall, top wall and two side walls, and a front surface connected to the bottom wall, top wall and two side walls, to form a box. The front surface is formed of a two-way mirrored surface so that the interior of the housing is not visible from the outside but the outside is visible from the interior of the housing. Optionally, a rear wall can be attached to the housing to close the housing. However, if the housing is to be mounted on or in a wall, such a rear wall is not necessary. The front surface or rear wall can be removable, or hinged to allow access to the interior of the box.

There is a connection to a power supply disposed in the housing and transformer connected to the power supply. Plugging the mobile telephone into the transformer allows a constant supply of power to the mobile telephone, so no separate charging of the battery in the mobile telephone is required. While the mobile telephone is usually equipped with a microphone, the housing includes a supplemental microphone that is more powerful and equipped to pick up sounds from outside the housing. The microphone preferably extends through an aperture in the bottom of the housing. The housing also includes a connector for connecting the mobile telephone to the transformer and microphone. The connector is positioned so that when the mobile telephone is connected, the camera on the mobile telephone faces the front surface and is adapted to record images through the front surface. Typically, this connector is in the form of a prong that the mobile telephone is placed on so as to stand upright. Different connectors can be supplied for the various different brands of mobile telephones.

The mobile telephone typically is equipped with a camera, a microprocessor, a battery and a transmitter/receiver for transmitting and receiving information from the microprocessor over a wireless internet service. When the mobile telephone is connected to the housing and power is supplied to the mobile telephone via the power supply, the camera of the mobile telephone is configured to record video data through the mirrored surface of the housing and the microphone is configured to record sounds from outside the housing. The microprocessor is configured to send the recorded video data from the camera and audio data from the microphone over the wireless internet service to a remote computer where it can be viewed remotely, either elsewhere in the house, or from a remote location. Thus, the mobile telephone can be converted into a home security system to monitor entrances, or can be used as a baby monitor, child-care provider monitor, or any type of security monitor.

In a further embodiment, there can be a speaker disposed within the housing and connected to the microprocessor and power supply, so that the speaker can broadcast sounds sent over the wireless internet service to the microprocessor, thus turning the housing into an intercom system as well.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an exterior view of the housing according to the invention;

FIG. 2 shows a bottom view of the housing;

FIG. 3 shows the interior of the housing;

FIG. 4 shows the housing mounted to a wall with a mobile phone mounted therein;

FIG. 5 shows a schematic diagram of the components of the housing according to the invention as they work with the components of a mobile telephone; and

FIG. 6 shows how the invention is used as a security monitor for a home.

### DETAILED DESCRIPTION OF THE PREFERRED EMBODIMENT

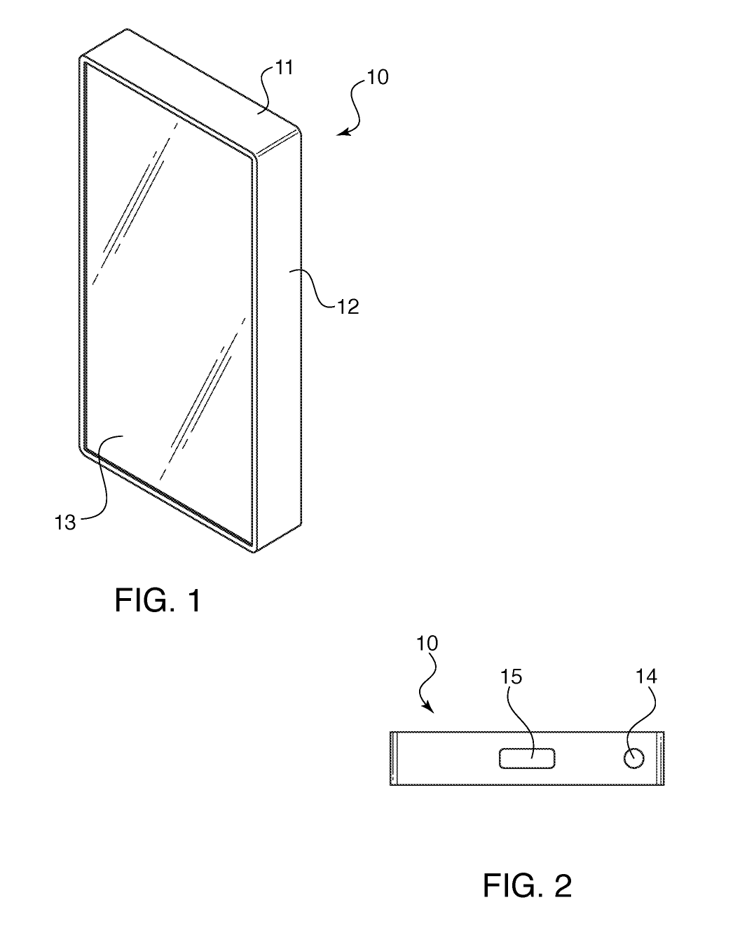

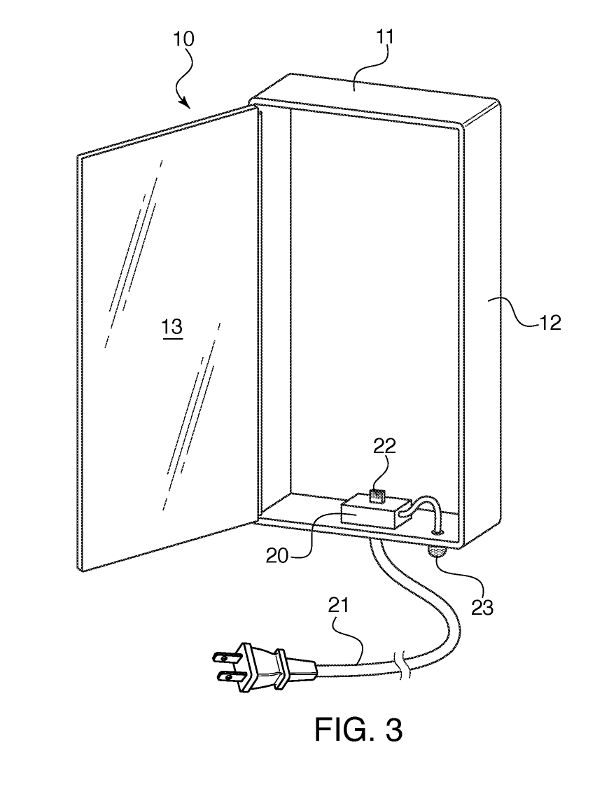

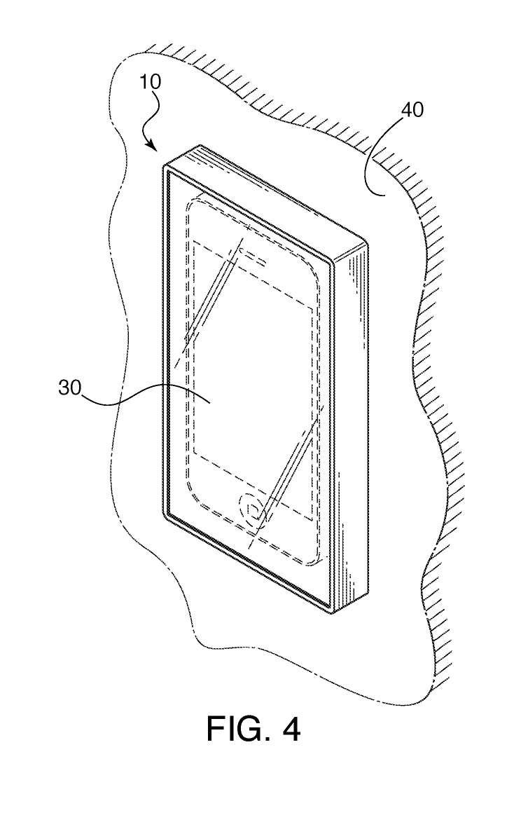

Referring now in detail to the drawings and, in particular, FIGS. 1-3 show the housing 10 according to the invention. Housing 10 has side walls 12, a top wall 11, and a front cover 13, which is made of two-way mirrored glass. The interior of housing 10 is not visible from the outside, but objects outside are visible from within housing 10. There is an aperture 15 for a power cord and aperture 14 for a microphone to extend though the bottom 16 of the housing. Inside the housing is disposed a transformer 20 connected to a power cord 21 for connection to a building's electrical system. A connector 22 is attached to the transformer so that a mobile telephone can be plugged directly into the housing 10. Once the power cord 12 is connected and the mobile telephone is plugged in, power is supplied continuously to the mobile telephone so that separate battery charging is not required. Connected to transformer 20 is a microphone 23 for recording sounds outside housing 10. A mobile telephone 30 can be plugged into housing 10 via connector 22, as shown in FIG. 4. The mobile telephone cannot be seen through cover 13, but the camera inside mobile telephone 30 can record images outside of housing 10. Front surface 13 is connected to housing 10 via a hinge so that it can be opened up for access to the interior.

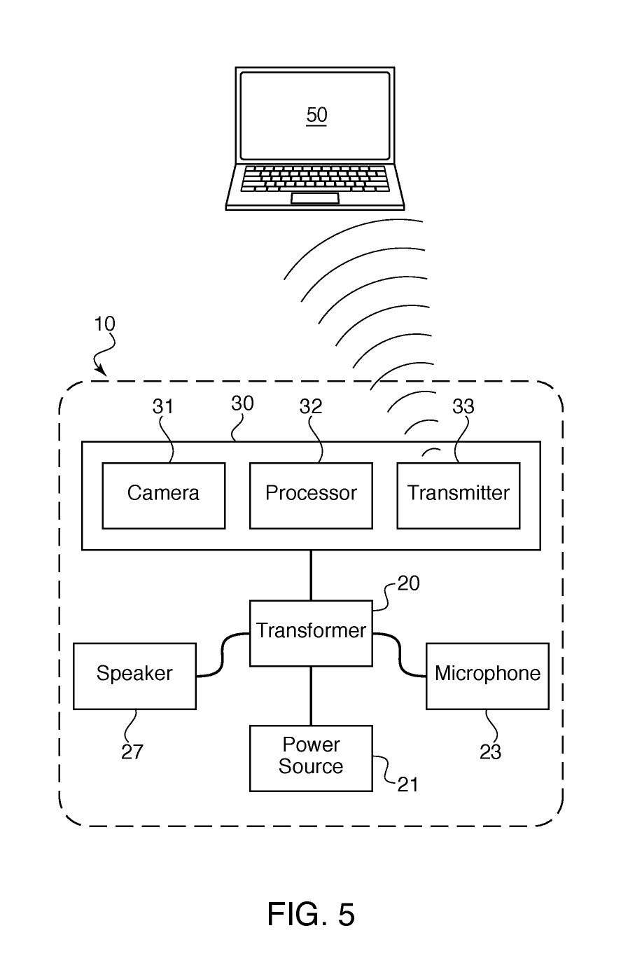

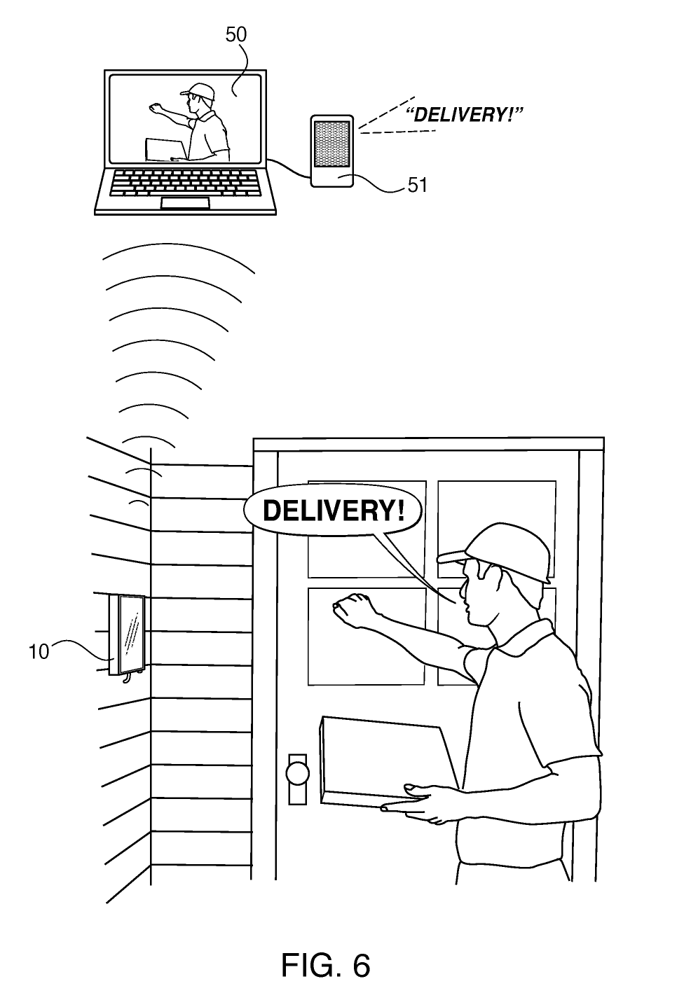

The components of the complete security system are shown in FIG. 5. Mobile telephone 30 has as its standard components a camera 31, a microprocessor 32 and a transmitter 33 for transmitting and receiving data via a wireless network. When mobile telephone 30 is plugged into housing 10, it is connected to transformer 20 and to microphone 23, and an external speaker 27 for broadcasting remote commands. Once mobile telephone 30 is plugged in and powered by power source 21, camera 31 records video data outside of housing 10 and sends it directly to remote computer 50 via processor 21 and transmitter 33. Similarly, microphone 23 picks up audio data from outside housing 10 and sends it to computer 50 for remote broadcasting. This way, and as shown in FIG. 6, housing 10 combined with mobile telephone 30 can act as a security system that can be monitored remotely. FIG. 6 shows housing 10 mounted to an exterior of a building for monitoring an entrance. The images and sounds of a person approaching the door can be recorded by the hidden mobile telephone 30 and sent directly to compute 50 for viewing and broadcasting via speaker 51. In addition, commands can be sent from computer 50 to mobile telephone 30 for transmission via speaker 27 in housing 10, so that housing 10 can also act as an intercom.

Accordingly, while only a few embodiments of the present invention have been shown and described, it is obvious that many changes and modifications may be made thereunto without departing from the spirit and scope of the invention.

1. A housing for a mobile telephone comprising:
a bottom wall, top wall and two side walls;
a front surface connected to at least one of the bottom wall, top wall and two side walls, the front surface being formed of a two-way mirrored surface so that the interior of the housing is not visible from the outside but the outside is visible from the interior of the housing;
a connection to a power supply disposed in the housing;
a transformer connected to the power supply;
a microphone connected to the transformer and extending through an aperture in the housing;
a mobile telephone disposed within the housing, the mobile telephone having a camera, a microprocessor, a battery and a transmitter/receiver for transmitting information from the microprocessor and receiving information over a wireless Internet service, wherein the microphone is separate from the mobile telephone; and
a connector for connecting the mobile telephone to the transformer, the connector being positioned so that when the mobile telephone is connected, a camera on the mobile telephone faces the front surface,
wherein power is supplied to the mobile telephone via the power supply, wherein the camera of the mobile telephone is configured to record video data through the mirrored surface of the housing, wherein the microphone is configured to record sounds from outside the housing, and wherein the microprocessor is configured to send the video data from the camera and audio data from the microphone over the wireless internet service to a remote computer.

2. (canceled)

3. The housing according to claim 1, wherein the connector is mounted to the bottom of the housing.

4. The housing according to claim 1, wherein the microphone is configured to be connected to the mobile telephone when the mobile telephone is connected to the connector.

5. (canceled)

6. The housing according to claim 1, further comprising a speaker disposed within the housing and connected to the microprocessor and power supply, the speaker being configured to broadcast sounds sent over the wireless internet service to the microprocessor.
